(19) United States
(12) Patent Application Publication
(10) Pub. No.: US 2025/0044404 A1
(43) Pub. Date: Feb. 6, 2025

(54) RADAR APPARATUS AND METHOD FOR PRODUCING A RADAR APPARATUS

(71) Applicant: Robert Bosch GmbH, Stuttgart (DE)

(72) Inventors: Armin Himmelstoss, Weissach Im Tal (DE); Andreas Kugler, Alfdorf (DE); Corinne Grevent, Ostfildern (DE)

(21) Appl. No.: 18/715,770

(22) PCT Filed: Jan. 11, 2023
(86) PCT No.: PCT/EP2023/050505

§ 371 Date: Jun. 3, 2024

(30) Foreign Application Priority Data
Mar. 2, 2022 (DE) 10 2022 202 140.1

(51) Int. Cl. G01S 7/03; G01S 13/931

(52) U.S. Cl. CPC G01S 7/032; G01S 13/931

(57) ABSTRACT

A radar apparatus. The radar apparatus includes a printed circuit board and a signal generating circuit which is disposed at least indirectly on the printed circuit board, is electrically coupled to the printed circuit board, and is configured to generate a radar signal. The radar apparatus additionally includes a waveguide antenna device which is disposed at least indirectly on the printed circuit board and is at least partly formed on the basis of injection-molded plastic. The radar apparatus additionally includes a waveguide coupling device, wherein the signal generating circuit is disposed on or in the waveguide coupling device, and the waveguide coupling device is configured to couple the radar signal generated by the signal generating circuit into the waveguide antenna device.

### FIELD

The present invention relates to a radar apparatus and to a method for producing a radar apparatus. The present invention relates in particular to a radar apparatus for use in a motor vehicle.

### BACKGROUND INFORMATION

Driver assistance systems support the driver or can, at least in part, control the vehicle independently. A fundamental requirement for the provided functions is a good knowledge of the surroundings of the vehicle. Driver assistance systems therefore access sensor data generated by sensors of the vehicle. Typical sensors include vehicle cameras, LiDAR sensors, infrared sensors and, in particular, radar sensors.

The radar sensor system has to have a high sensitivity and a good separation capability. This places high demands on the antenna field of the radar sensor. The costs should be kept low as well. Costs can be reduced by integrating; e.g. by integrating electrical signal generation, signal transmission, signal reception and signal processing into a single system-on-chip (SoC).

In addition to conventional patch antenna arrays, it is also possible to use waveguides antennas. Whereas conventional patch antenna arrays are typically narrowband, waveguide antennas can cover bandwidths up to about 10 GHz. Waveguide antennas also promise better efficiency, lower losses and a greater field of view than the current patch antennas. An example of a waveguide interface is described in U.S. Patent Application Publication No. US 2020/0365971 A1.

### SUMMARY

The present invention provides a radar apparatus and a method for producing a radar apparatus.

Preferred embodiments of the present invention are disclosed herein.

According to a first aspect, the present invention provides a radar apparatus. According to an example embodiment of the present invention, the radar apparatus includes a printed circuit board and a signal generating circuit which is disposed at least indirectly on the printed circuit board, is electrically coupled to the printed circuit board and is configured to generate a radar signal. The radar apparatus further comprises a waveguide antenna device which is disposed at least indirectly on the printed circuit board and is at least partly formed on the basis of injection-molded plastic. The radar apparatus also comprises a waveguide coupling device, wherein the signal generating circuit is disposed on or in the waveguide coupling device, wherein the waveguide coupling device is configured to couple the radar signal generated by the signal generating circuit into the waveguide antenna device.

According to a second aspect of the present invention of the present invention, the present invention provides to a method for producing a radar apparatus. According to an example embodiment of the present invention, the method includes providing a printed circuit board, wherein a signal generating circuit is disposed at least indirectly on the printed circuit board, wherein the signal generating circuit is electrically coupled to the printed circuit board and is configured to generate a radar signal. The method further includes at least partially overmolding the printed circuit board comprising the signal generating circuit with plastic in an injection mold structured with waveguide channels. The method also includes removing the injection mold and metallizing the waveguide channels to form a waveguide antenna device. The method further includes exposing coupling elements of a waveguide coupling device, wherein the waveguide coupling device is configured to couple the radar signal generated by the signal generating circuit into the waveguide antenna device via the coupling elements.

An example embodiment of the present invention provides a radar apparatus comprising a printed circuit board, a signal generating circuit and a waveguide coupling device, which can be combined to form a high-frequency package onto which a waveguide antenna device is molded using a plastic injection molding process. There is therefore no need for high-frequency laminates on the printed circuit board for the radar apparatuses. Adapter components can be produced using cost-effective printed circuit board technology. The radar apparatus can be produced cost-effectively by using surface-mounted device (SMD) processes in combination with direct injection molding (DIM) methods.

Coupling the radar signal directly into the waveguide antenna makes it possible to cost optimize the printed circuit board material without millimeter-wave requirements and limitations.

According to another example embodiment of the radar apparatus of the present invention, the waveguide coupling device is configured to couple the radar signal generated by the signal generating circuit directly into waveguide channels of the waveguide antenna device. The waveguide antenna device is molded directly onto the waveguide coupling device in a connection region adjoining the waveguide channels. There is in particular no air gap in this connection region. The plastic is preferably molded directly onto the printed circuit board, the signal generating circuit or the waveguide coupling device. Only coupling regions (feed channels) for coupling the radar beams into the waveguide antenna device are left open. The absence of an air gap makes it possible to eliminate the need for otherwise necessary tolerance compensation regions and also prevent high-frequency coupling to adjacent coupling regions.

According to another example embodiment of the radar apparatus of the present invention, the waveguide antenna device is molded directly onto the signal generating circuit. This makes it possible to eliminate the need for additional special overmolding, which simplifies production and reduces costs.

According to another embodiment of the radar apparatus of the present invention, the waveguide coupling device comprises at least one metallized high-frequency structure for coupling the radar signal generated by the signal generating circuit into the waveguide antenna device. The radar signal is coupled directly via the metallized high-frequency structure.

According to another embodiment of the radar apparatus of the present invention, metallized side walls of a waveguide channel of the waveguide antenna device are in contact with the metallized high-frequency structure. The entire coupling region is therefore metallized.

According to another embodiment of the radar apparatus of the present invention, metallized side walls of a waveguide channel of the waveguide antenna device are in contact with a solder mask disposed between the waveguide antenna device and the waveguide coupling device. The solder mask separates the metallized side walls of the waveguide channel from the waveguide coupling device.

According to another embodiment of the radar apparatus of the present invention, the metallized high-frequency structure is spaced apart from the solder mask.

According to another embodiment of the radar apparatus of the present invention, metallized side walls of a waveguide channel of the waveguide antenna device are spaced apart from the waveguide coupling device by an injection-molded plastic section.

According to another embodiment of the radar apparatus of the present invention, the metallized side walls at the transition to the waveguide coupling device comprise a section that extends parallel to the metallized high-frequency structure. The coupling can be influenced by different configurations of the metallized side walls.

According to a preferred embodiment of the radar apparatus of the present invention, the waveguide coupling device comprises an interposer which is configured to conduct the radar signal generated by the signal generating circuit to the waveguide antenna device.

According to another embodiment of the present invention, the radar apparatus comprises at least one heat sink, which is at least indirectly connected to the signal generating circuit and/or the printed circuit board in order to dissipate heat. This makes it possible to prevent overheating of the radar apparatus.

According to another embodiment of the radar apparatus of the present invention, the signal generating circuit is a system on a chip circuit or a monolithic microwave integrated circuit (MMIC).

Further advantages, features and details of the present invention will emerge from the following description, in which different embodiment examples of the present invention are described in detail with reference to the figures.

### BRIEF DESCRIPTION OF THE DRAWINGS

FIG. 1 shows a schematic cross-sectional view of a radar apparatus according to a first example embodiment of the present invention.

FIG. 2 shows a schematic cross-sectional view of a radar apparatus according to a second example embodiment of the present invention.

FIG. 3 shows a schematic cross-sectional view of a radar apparatus according to a third example embodiment of the present invention.

FIG. 4 shows a schematic cross-sectional view of a radar apparatus according to a fourth example embodiment of the present invention.

FIG. 5 shows a schematic plan view and cross-sectional view of a radar apparatus according to a fifth example embodiment of the present invention.

FIG. 6 shows a schematic cross-sectional view of a radar apparatus according to a sixth example embodiment of the present invention.

FIG. 7 shows a schematic cross-sectional view of a radar apparatus according to a seventh example embodiment of the present invention.

FIG. 8 shows a schematic cross-sectional view of a radar apparatus according to an eighth example embodiment of the present invention.

FIG. 9 shows a schematic cross-sectional view of a radar apparatus according to a ninth example embodiment of the present invention.

FIG. 10 shows a schematic cross-sectional view of a radar apparatus according to a tenth example embodiment of the present invention.

FIG. 11 shows a schematic cross-sectional view of a radar apparatus according to an eleventh example embodiment of the present invention.

FIG. 12 shows a schematic cross-sectional view of a radar apparatus according to a twelfth embodiment of the present invention.

FIG. 13 shows a flow chart of a method for producing a radar apparatus, according to an example embodiment of the present invention.

In all figures, identical or functionally identical elements and apparatuses are provided with the same reference sign. The numbering of method steps is for the sake of clarity and is generally not intended to imply a specific chronological order. It is in particular also possible to carry out multiple method steps at the same time.

### DETAILED DESCRIPTION OF EXAMPLE EMBODIMENTS

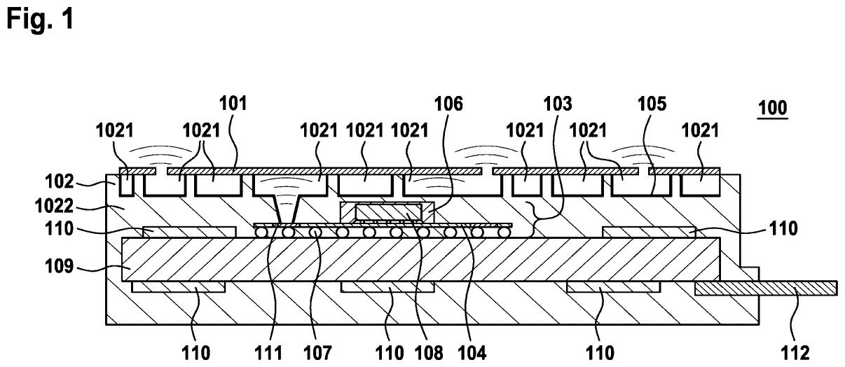

FIG. 1 shows a schematic cross-sectional view of a radar apparatus 100. The radar apparatus 100 includes a printed circuit board 109 (PCB) comprising surface-mounted devices (SMD) 110 and plug contacts 112.

Coupled to the printed circuit board 109 is a signal generating circuit 108, wherein said signal generating circuit is integrated into a waveguide coupling device 103, which can also be referred to as a waveguide launcher. This waveguide coupling device 103 is integrated into the radar chip package, so that no millimeter wave signal is transmitted on the printed circuit board 109.

The waveguide coupling device 103 comprises a molding compound 106 which surrounds the signal generating circuit 108 on a side facing away from the printed circuit board 109. According to other embodiments, the molding compound 106 can be absent.

The waveguide coupling device 103 also comprises an interposer 104. The interposer 104 is not surrounded by the molding compound 103 in the outer regions in order to enable low-loss coupling from the waveguide coupling device 103 into a waveguide antenna device 102.

The signal generating circuit 108 is disposed on the interposer 104 and the interposer 104 is connected to the printed circuit board 109 via solder balls or pads 107, so that a ball grid array (BGA)- or land grid array (LGA)-like housing is formed.

The signal generating circuit 108 is a monolithic microwave integrated circuit (MMIC). According to other embodiments, the signal generating circuit 108 can also be a system on a chip circuit. The signal generating circuit 108 is configured to generate and receive a radar signal (HF signal).

The waveguide antenna device 102 is disposed on the printed circuit board 109 and surrounds the waveguide coupling device 103 and the signal generating circuit 108 integrated therein. The waveguide antenna device 102 is formed by overmolding the printed circuit board 109 with the waveguide coupling device 103 and the signal generating circuit 108 with a plastic 1022, such as a thermoset or thermoplastic.

The waveguide antenna device 102 comprises waveguide channels 1021 with metallized side walls 105. A perforated plate 101 is disposed on the waveguide channels 1021. The waveguide coupling device 103 is configured to couple the radar signal generated by the signal generating circuit 108 into the waveguide antenna device 102. The radar signal is emitted through openings in the perforated plate 101.

The transition to the waveguide antenna device 102 is advantageously realized on a portion of the interposer 104 that is not surrounded by the molding compound 103, which reduces HF losses and ensures high bandwidth. Coupling is carried out via a metallized high-frequency structure 111.

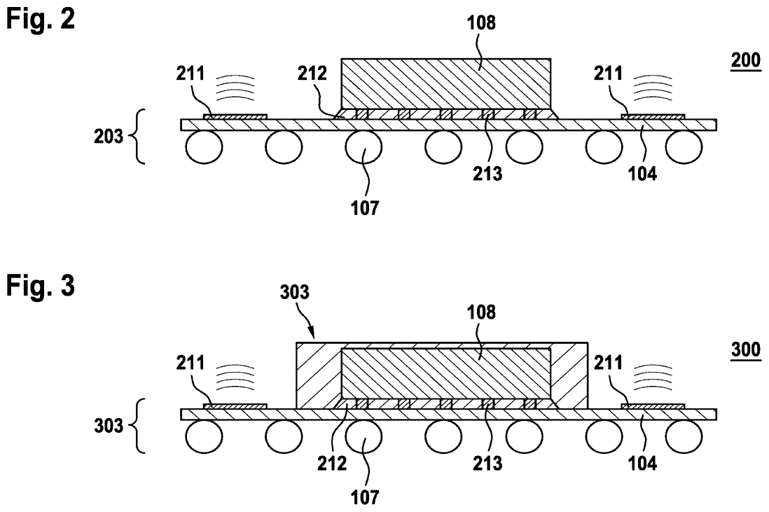

FIG. 2 shows a schematic cross-sectional view of a detail of a radar apparatus 200. The signal generating circuit 108 is applied onto the interposer 104 using flip chip technology and is connected to the interposer 104 by means of contacts 213. The signal generating circuit 108 is not surrounded by a molding compound. It is therefore a bare die structure. High-frequency (HF) structures 211 are realized in the conductive layers in the lateral regions of the printed circuit board. These are configured to couple the radar signal generated by the signal generating circuit 108 into an adjoining (not depicted) waveguide antenna device. A capillary underfill (CUF) or molded underfill (MUF) 212 is formed between the signal generating circuit 108 and the interposer 104. The waveguide coupling device 203 in the radar apparatus 200 is formed by the interposer 104 with CUF or MUF 212, contacts 213 and HF structures 211. The printed circuit board 109 is not shown. The component of the radar apparatus 200 that is shown can be referred to as a launcher in package. The not shown waveguide antenna device is applied using an injection molding process. In FIG. 2 and also in the following FIGS. 3 to 11, not depicted components can be provided as in FIG. 1.

FIG. 3 shows a schematic cross-sectional view of a launcher in package of a radar apparatus 300. The structure substantially corresponds to the structure illustrated in FIG. 2, in particular with respect to the waveguide coupling device 303. The signal generating circuit 108 is additionally partially surrounded by a molding compound 303. The lateral regions of the interposer 104 are not surrounded by molding compound 303, however.

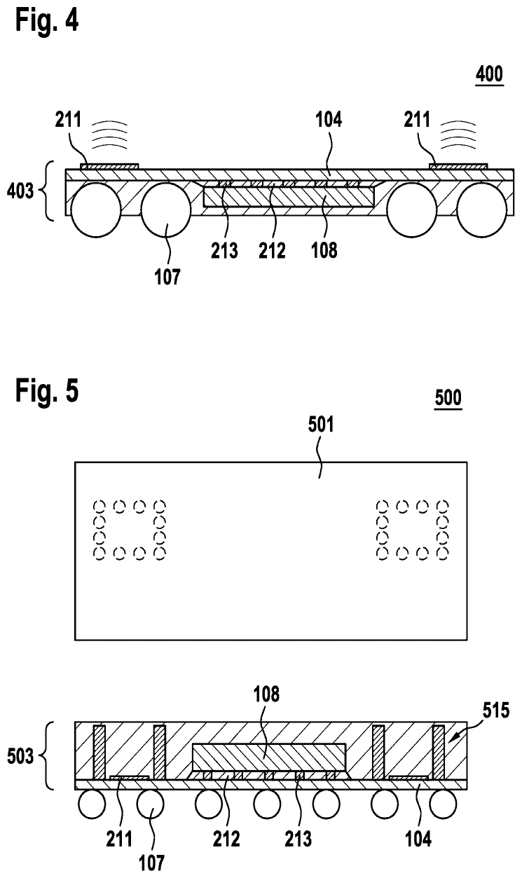

FIG. 4 shows a schematic cross-sectional view of a launcher in package of a radar apparatus 400. The signal generating circuit 108 is disposed on an underside of the interposer 104 of the waveguide coupling device 403 and surrounded by molding compound 403. The HF structures 211 are disposed on the upper side of the interposer 104, and the HF wave signals are emitted upward and coupled into the waveguide antenna device (not shown).

FIG. 5 shows a schematic plan view (top) and cross-sectional view (bottom) of a launcher in package of a radar apparatus 500. The molding compound 501 is also formed on the interposer 104 in the outer regions, wherein the HF signals are coupled from the waveguide coupling device 503 into the (not depicted) waveguide antenna device by means of through-contacts (vias) 515. The vias 515 extend through the molding compound 501 and are produced using through mold via technology.

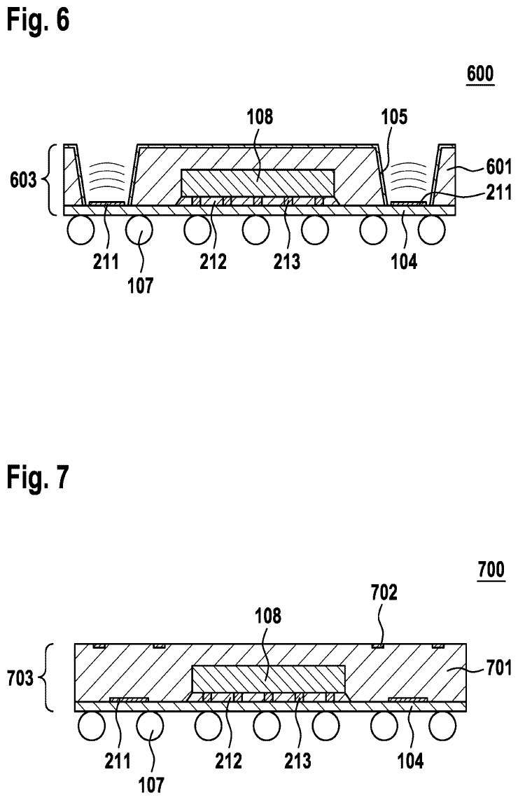

FIG. 6 shows a schematic cross-sectional view of a launcher in package of a radar apparatus 600. A waveguide coupling device 603 surrounded by a molding compound 601 is provided, wherein the HF structures 211 are exposed or at least partially covered by a thin molding compound layer.

FIG. 7 shows a schematic cross-sectional view of a launcher in package of a radar apparatus 700. This differs from the radar apparatus 600 shown in FIG. 6 in that the HF structures 211 of the waveguide coupling device 703 in a molding compound 701 are not exposed. Above the HF structures 211 there are beam shaping elements 702.

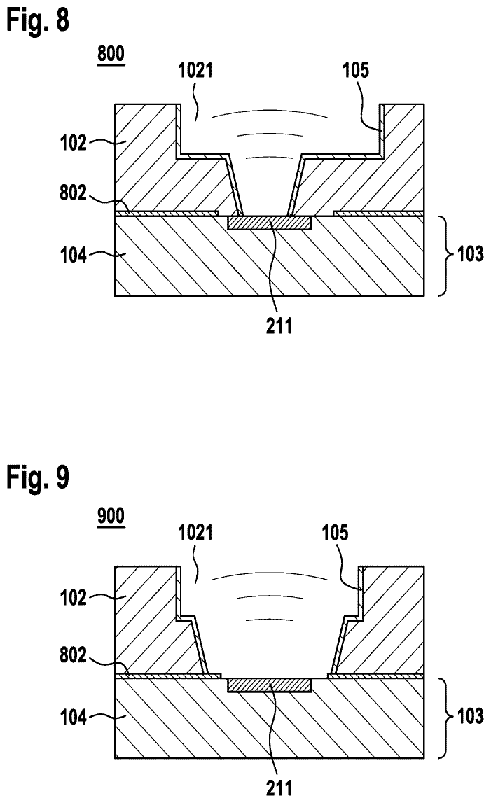

FIG. 8 shows a schematic cross-sectional view of a detail of a radar apparatus 800, specifically a coupling structure. It comprises a waveguide channel 1021 with metallized side walls 105 which are in contact with the metallized high-frequency structure 211. A solder mask 802 is disposed outside the coupling structure between the waveguide antenna device 102 and the waveguide coupling device 103.

FIG. 9 shows a schematic cross-sectional view of a coupling structure of a radar apparatus 900. Metallized side walls 105 of a waveguide channel 1021 of the waveguide antenna device 102 are in contact with a solder mask 802 disposed between the waveguide antenna device 102 and the waveguide coupling device 103. The metallized high-frequency structure 211 is spaced apart from the solder mask 802.

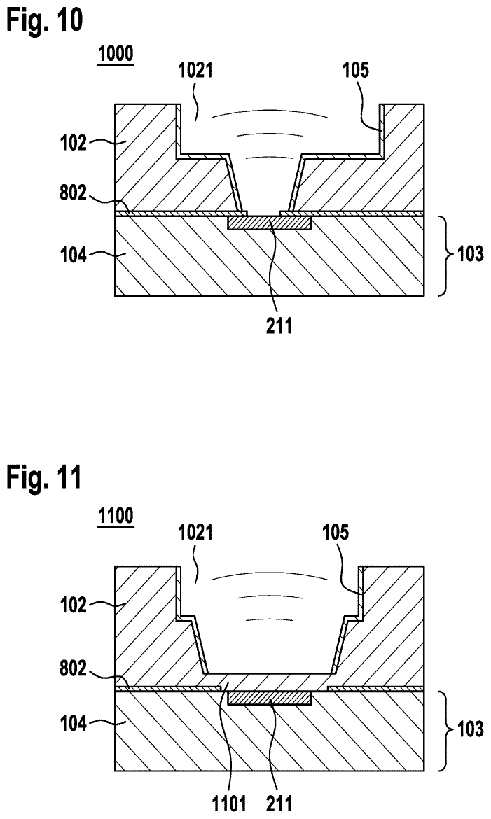

FIG. 10 shows a schematic cross-sectional view of a coupling structure of a radar apparatus 1000. Unlike the coupling structure shown in FIG. 9, the metallized high-frequency structure 211 overlaps with the solder mask 802.

FIG. 11 shows a schematic cross-sectional view of a coupling structure of a radar apparatus 1100. The metallized side walls 105 of the waveguide channel 1021 of the waveguide antenna device 102 are spaced apart from the waveguide coupling device 103 by an injection-molded plastic section 1101. The spacing can be between 20 μm and 100 μm to 500 μm, for example. The injection-molded plastic section 1101 can be made of a thermoset or thermoplastic material, for instance the same material as the structure of the rest of the waveguide 102. However, another dielectric material can be provided as well.

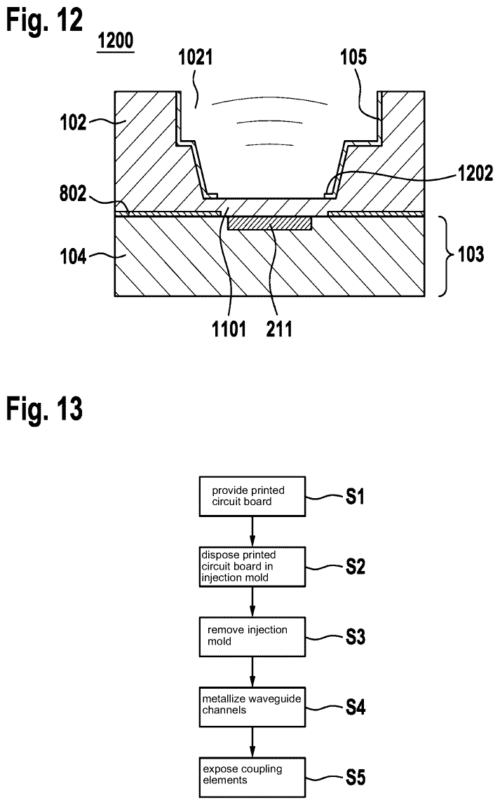

FIG. 12 shows a schematic cross-sectional view of a coupling structure of a radar apparatus 1200. Unlike the coupling structure shown in FIG. 11, the metallized side walls 105 at the transition to the waveguide coupling device 103 comprise a section 1202 that extends parallel to the metallized high-frequency structure 211.

FIG. 13 shows a flow chart of a method for producing a radar apparatus.

In a first method step S1, a printed circuit board 109 is provided, wherein a signal generating circuit 108 is disposed at least indirectly on the printed circuit board 109. The signal generating circuit 108 is electrically coupled to the printed circuit board 109 and is configured to generate a radar signal.

In a second method step S2, the printed circuit board 109 comprising the signal generating circuit 108 is disposed in an injection mold structured with waveguide channels and at least partially overmolded with plastic, such as a thermoset or thermoplastic. A transition region to the waveguide channels can be left free.

In a step S3, the injection mold is removed. In a step S4, the waveguide channels are metallized to form a waveguide antenna device 102. This can be done in such a way that the metallic transition in the coupling region is not metallized as well, for example using masks. The metal can alternatively also be deposited on metallic structures in the coupling region. The metal is then removed again.

The metallization can be physical or chemical or galvanic. The metal can be removed using a laser or with wet-chemical or dry etching processes.

In a step S5, coupling elements of a waveguide coupling device 103 are exposed, wherein the waveguide coupling device 103 is configured to couple the radar signal generated by the signal generating circuit 108 into the waveguide antenna device 102 via the coupling elements.

1-10. (canceled)

11. A radar apparatus, comprising:
a printed circuit board;
a signal generating circuit, which is disposed at least indirectly on the printed circuit board, is electrically coupled to the printed circuit board, and is configured to generate a radar signal;
a waveguide antenna device, which is disposed at least indirectly on the printed circuit board and is at least partly formed on the basis of injection-molded plastic; and
a waveguide coupling device, wherein the signal generating circuit is disposed on or in the waveguide coupling device, and wherein the waveguide coupling device is configured to couple the radar signal generated by the signal generating circuit into the waveguide antenna device.

12. The radar apparatus according to claim 11, wherein the waveguide coupling device is configured to directly couple the radar signal generated by the signal generating circuit into waveguide channels of the waveguide antenna device, and wherein the waveguide antenna device is molded directly onto the waveguide coupling device in a connection region adjoining the waveguide channels.

13. The radar apparatus according to claim 11, wherein the waveguide antenna device is molded directly onto the signal generating circuit.

14. The radar apparatus according to claim 11, wherein the waveguide coupling device includes at least one metallized high-frequency structure for coupling the radar signal generated by the signal generating circuit into the waveguide antenna device.

15. The radar apparatus according to claim 14, wherein metallized side walls of a waveguide channel of the waveguide antenna device are in contact with the metallized high-frequency structure.

16. The radar apparatus according to claim 14, wherein metallized side walls of a waveguide channel of the waveguide antenna device are in contact with a solder mask disposed between the waveguide antenna device and the waveguide coupling device.

17. The radar apparatus according to claim 16, wherein the metallized high-frequency structure is spaced apart from the solder mask.

18. The radar apparatus according to claim 14, wherein metallized side walls of a waveguide channel of the waveguide antenna device are spaced apart from the waveguide coupling device by an injection-molded plastic section.

19. The radar apparatus according to claim 15, wherein the metallized side walls at the transition to the waveguide coupling device include a section that extends parallel to the metallized high-frequency structure.

20. A method for producing a radar apparatus, comprising the following steps:
providing a printed circuit board, wherein a signal generating circuit is disposed at least indirectly on the printed circuit board, wherein the signal generating circuit is electrically coupled to the printed circuit board and is configured to generate a radar signal;
at least partially overmolding the printed circuit board including the signal generating circuit with plastic in an injection mold structured with waveguide channels;
removing the injection mold;
metallizing the waveguide channels to form a waveguide antenna device; and
exposing coupling elements of a waveguide coupling device, wherein the waveguide coupling device is configured to couple the radar signal generated by the signal generating circuit into the waveguide antenna device via the coupling elements.
